(19) United States
(12) Patent Application Publication
(10) Pub. No.: US 2003/0141979 A1
(43) Pub. Date: Jul. 31, 2003

(54) Industrial microcomputer flame sensor with universal signal output and self-checking

(76) Inventors: Gary G. Wild, Rockford, IL (US); John D. Eley, Beloit, WI (US)

Correspondence Address: JOHN ELEY, GN ELECTRONICS, INC., SUITE 104, 9958 N. ALPINE RD., MACHESNEY PARK, IL, 61115, US

(21) Appl. No.: 10/056,040

(22) Filed: Jan. 28, 2002

(51) Int. Cl. G08B 17/12

(52) U.S. Cl. 340/577; 340/600; 250/554

(57) ABSTRACT

A flame detection system utilizing microcomputer control of a unique self-checking signal interruption system for checking the status of the sensing tube by employing solid state switches and a balance beam shutter. The microcomputer uses a diode and a solid state relay circuit to generate a compatible signal output to a burner control.

### REFERENCES CITED (RELATED APPLICATIONS)

U.S. Patent Documents

| | | | |
|---|---|---|---|
| 2911540 | Nov., 1959 | Powers | 250/554. |
| 3742474 | Jun., 1973 | Muller | 340/578 |
| 3820097 | Jun., 1974 | .Larson | 307/117 |
| 4395638 | Jul., 1983 | .Cade | 250/554 |
| 4520390 | May, 1985 | Paredes | 505/445 |
| 4591725 | May, 1986 | Bryant | 250/554 |
| 4653998 | Mar., 1987 | Sohma et al | 431/79 |
| 4746178 | May, 1988 | .Canty | 362/576 |
| 4904986 | Feb., 1990 | Pinkaers | 340/578 |
| 4965601 | Oct., 1990 | Canty | 396/19 |
| 4977418 | Dec., 1990 | Canty | 396/19 |
| 5230556 | Jul., 1993 | Canty | 362/562 |
| 5245196 | Sep., 1993 | Cabalfin | 250/554 |
| 5300836 | Apr., 1994 | Cha | 327/113 |
| 5510772 | Apr., 1996 | Lasenby | 340/578 |
| 5548277 | Aug., 1996 | Wild | 340/578 |
| 5549469 | Aug., 1996 | Wild | 431/79 |
| 5952930 | Aug., 1999 | Umeda et al | 340/579 |
| 5993194 | Nov., 1999 | Lemelson et al | 431/79 |

### ADDITIONAL REFERENCES

“45UV5 self-checking UV scanners”, brochure of Fireye, Inc in Derry N.H.

“Electronic Flame Supervision”, brochure of Pyronics, Inc. in Cleveland, Ohio.

### BACKGROUND OF THE INVENTION

Numerous industrial processes utilize combustion units, such as, for example, furnaces, ovens, incinerators, dryers, and boilers. Typically these types of equipment have more than one burner each operating with various fuels. Each of these burners is equipped with some type of flame sensor. The flame sensors are always mounted on the burner in such a way that the sensor is able to detect a flame when one is present in the burner. The sensor then generates a signal, which is detected by a burner control system. The burner control in turn governs the start up and shut down of the burner according to a prescribed sequence. The purpose of this is to avoid the possibility of explosions and other failure, which could result in damage or injury to equipment or personnel. There are different types of sensors in use in industrial burner applications. One of these types is the Ultra-violet sensor.

Ultra-violet sensors do not actually come in contact with the flame in a burner as do flame rod electrodes. The Ultra violet flame detection system that employs a specialized sensor which detects the ultraviolet light radiated from a flame but is insensitive to other ranges of emitted light such as visible or infrared light. The typical Ultraviolet flame sensor is a sealed quartz glass tube filled with a type of a gas and containing two electrodes (anode and cathode). A high voltage is applied across the electrodes by the burner control. When the sensing tube becomes exposed to Ultraviolet light in the presents of the voltage presence across the electrodes, electrons are emitted from the cathode. These electrons ionize the gas in the tube and the gas becomes conductive. Current then begins to flow across the electrodes and the voltage potential drops. When the voltage potential drops far enough the conduction stops. This causes the voltage to rise again. If Ultraviolet light is still present from the flame the conduction process will start again when the voltage has risen far enough. This continual sequence results in a series of pulses emitted from the sensor when a flame is present. This series of pulses is then detected as a flame present signal by the burner control.

The Ultra-violet sensing tube is subject to mechanical abuse and possible failure from the way that it is constructed. The tube can fail in its operation in one of two ways. The first is if it becomes incapable of current conduction in the presence of Ultraviolet light from a flame. In this case either the gas I within the tube has escaped preventing the conduction of electron flow. The other case is when the electrodes themselves are either bend or in someway destroyed so that the distance is to great creating an impedance too high to establish current flow.

The other mode of failure is the state where the current flow across the two electrodes occurs spontaneously without the presence of the Ultraviolet light from the flame. In this case the sensing tube is indicating the presence of a flame when in fact no flame is present. This condition is commonly referred to in the industry as “run away”.

In most burner controls the circuitry is present to perform a check on the Ultraviolet sensing tube at the start of every sequence. In other words, if a control starts its burner sequence and the Ultraviolet sensor is already indicating that there is a flame present, the control will stop the sequence before the gas valves are opened and energize an alarm of some kind to indicate the sensor failure. Also possible is the condition where the burner does not shut down for very long periods of time. In these cases the operation of the ultraviolet sensing tube could go unchecked for a very long time and possibly lead to an incident where the Sensing tube is still indicating flame even when the flame has gone out for some reason. If this should occur without detection, the burner control may continue to energize the gas valves. This could create a potentially hazardous condition. What is needed is a Self-check Ultraviolet detection system with a very dependable means for checking the proper operation of the Ultraviolet sensing tube. In also needs the internal capability to monitor flame signal and automatically adjust or compensate for different flame levels in a burner A third important feature is the ability to interface to a variety of controls so that a self-checking scanner can be available for any burner control system.

### SUMMARY OF THE INVENTION

In view of the aforementioned discussion, the present invention provides a unique checking mechanism to the application of checking the Ultraviolet tube. The checking mechanism checks the proper operation of the sensing tube every ten seconds. This is done with a balance beam device that is driven magnetically in a circuit control by a microcomputer. The microcomputer initiates a checking sequence every 10 seconds. The balance beam is actuated through a pair of microcomputer controlled solid state relays.

In addition to this the microcomputer analyses the signal coming from the sensing tube through an ipto isolator. This signal is interpreted in such a way as to better detect the actual flame status and to distinguish changes in the signal causes by a break down of the sensing tube itself.

The unique output circuitry of the invention creates a universal flame signal interface which is compatible with a wide variety of flame and burner controls' signal input requirements. This permits a wide range of uses and a nearly universal self-check flame detection system

### BRIEF DESCRIPTION OF THE DRAWINGS

The accompanying drawings illustrate the aspects and concepts of the invention. In the drawings:

FIG. 1 is a block diagram of the invention concepts incorporating several new concepts in the process. The invention is made of several unique modules, which will be described in detail below

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PERFERRED EMBODIMENTS

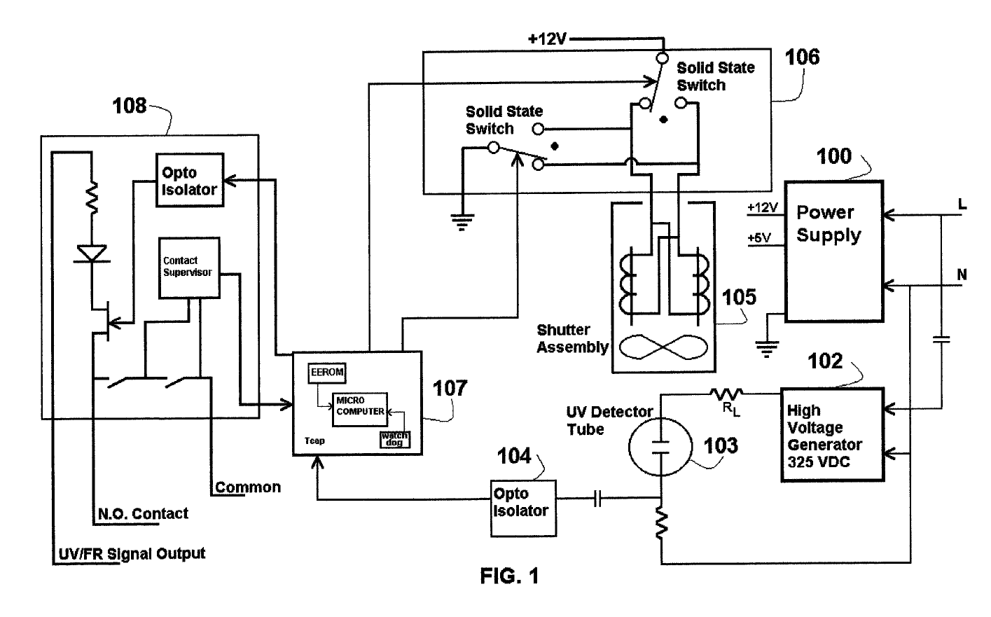

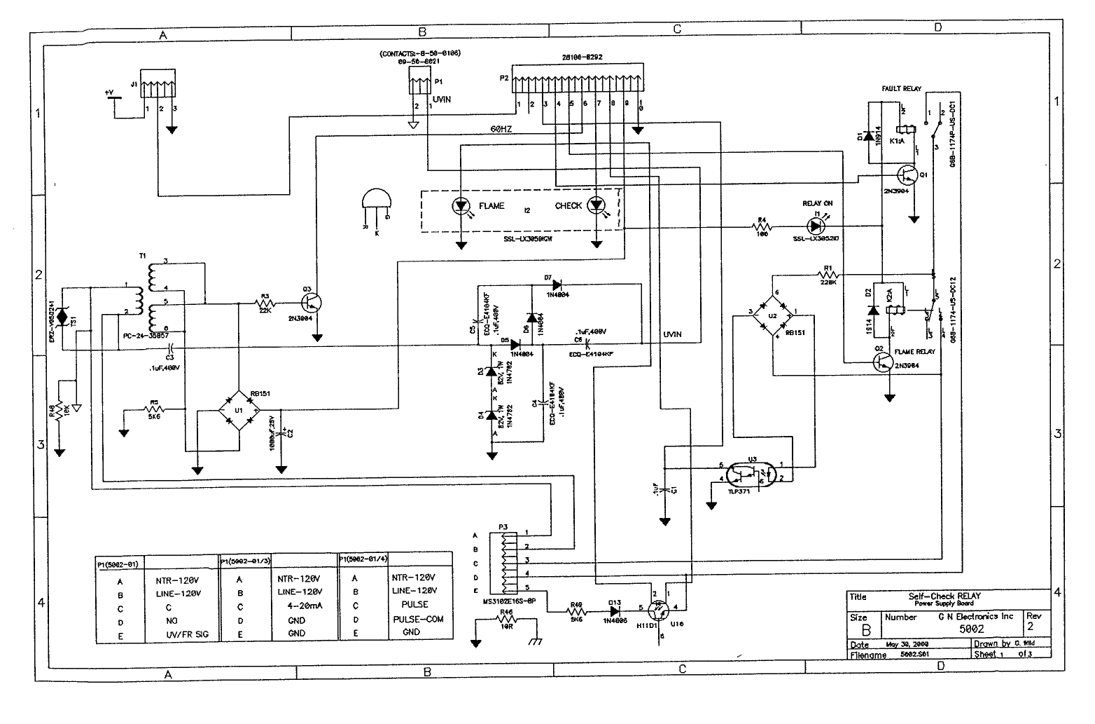

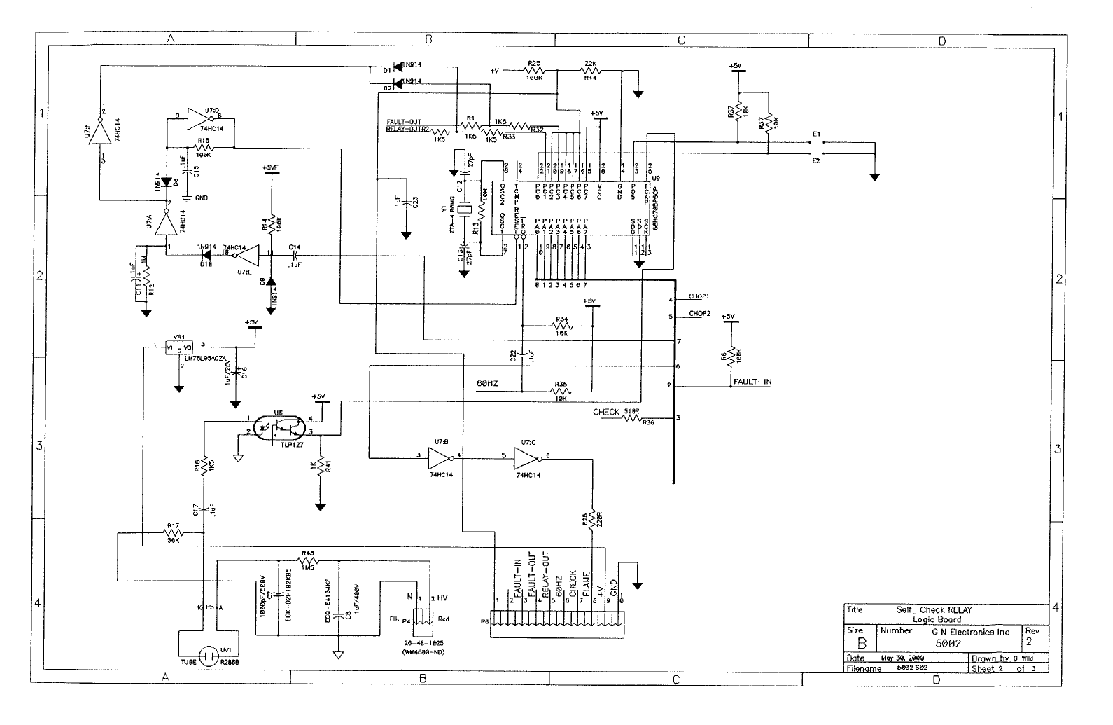

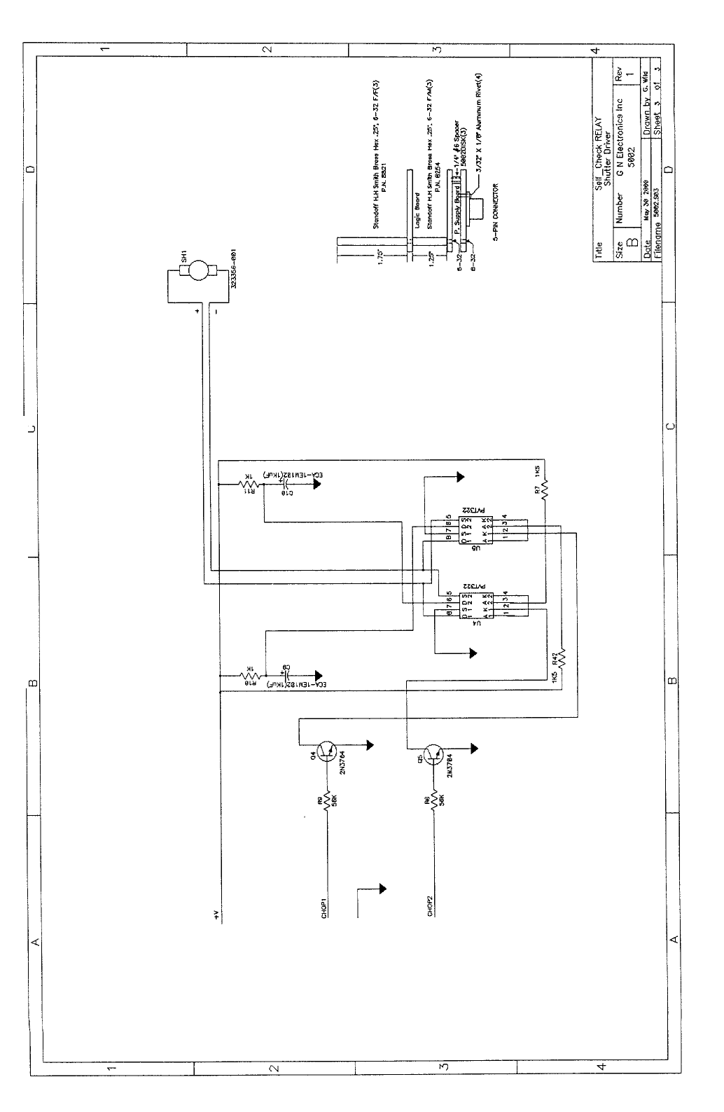

In the drawing labeled FIG. 1 the power supply 100 supplies the 5 volts and the 12 volts required to operate the electronics. The High Voltage Generator 102 provides power in the form of high voltage to energize the ultraviolet sensing tube.

Ultra-Violet Sensing

When a flame signal is present a frequency pulse occurs at RL due to the UV sensing phenomenon explained above. This frequency pulse is then sent to the UV opto-isolator 104. This frequency signal is then sent to the microcomputer module 107 where it is interpreted as flame signal.

The microcomputer 107 has several functions.

Firstly, the microcomputer module receives the frequency signals from the UV ipto-isolator 104. When a flame signal is present the microcomputer, the microcomputer creates a combination flame output signal using the circuit 108. The circuit in 108 is also a unique concept, which consisted of a solid state switch and a rectifier circuit. By modulating the solid state switch the microcomputer creates a frequency output signal with a direct current component. This output signal is compatible with both for UV and Flame Rod type burner controls.

Second the microcomputer monitors all the components in the overall system. The Microcomputer verifies the flame sensing tube 103 is functioning properly. It does this through the control of two solid state switches 105 which inter operates a balance beam signal interrupter to the Ultraviolet sensing tube. By monitoring the signal from the sensing tube during the checking period the system will shut down when a sensing fault occurs

Turning now to the schematic drawing labeled Self-Check RELAY Power Supply board.

AC line voltage is supplied to the primary of transformer T1. The secondary of T1 has two windings. Windings marked 3 & 4 supply the Voltage for +V which is the rectified (U1 and supplied as power to the relay driving circuits (+12 Vdc) through resistor R4. The Fault Relay is a supervisory relay and will open the output circuit in the event of a failure. The Flame Relay is energized through Q2 in the event that a flame is detected. The relay contacts are supervised through the opto-coupler U3 and the rectifier U2. The circuit comprising D3, D4, D5, D6, D7 and capacitors C3, C4, C5, and C6 comprise the voltage multiplier creating the voltage at UVIN (300 VDC) that supplies the voltage to the UV sensing tube. The circuit comprising D13, R49 and U10 is controlled PA4 from the microcomputer. When pulsed by the microcomputer this circuit creates a pulsed DC output, which is equivalent to the DC current required by a flame rod type burner control. The DC pulses are also equivalent to the frequency pulse requirement of the Ultraviolet type burner controls. This allows a unique interface to various burner controls in the industry.

Turning now to the schematic drawing labeled Self-Check RELAY Logic board. The output of the TUBE (UV1) is coupled to the opto-coupler U6 and from there it is inputted into the Tcap input on the microcomputer U9. Voltage regulator VR1 generates 5V from the +V power supply and supplies the 5V to various components. The watchdog is comprised of U7; A, U7; D, U7E, U7F, D8, D10, and D9. The Microcomputer sends pulses to the watchdog circuit through C14 while it is running. If the microcomputer should freeze or shut down and not send the pulses the output from U7:D would go high and send a reset signal to the microcomputer on the reset input. The microcomputer sends two control signals out of PA6 and PA5 to CHOP1 and CHOP2 respectively. These signals control the driver circuits for the shutter.

Turning now to the schematic drawing labeled Self-Check RELAY Shutter Driver. The signals Chop 1 and Chop 2 fire two solid state opto-coupled switches U4 and U5 through the transistors Q5 and Q4 respectively. When U5 is activated the negative side of the shutter SH1 is connected to ground through the contact S1 to D1 on U5. The positive side of the shutter SH1 is connected to power through the contact S2 to D2 on U5. When U4 is activated the positive side of the shutter SH1 is connected to ground through the contact S1 to D1 on U4. The negative side of the shutter SH1 is connected to power through the contact S2 to D2 on U5. This causes the shutter to rotate in front of the tube UV1 to check its operation. This rotation is done on a 10-second time period where every tenth second the shutter is blocking the tube UV1.

The entire system as described provided a level of flexibility and reliability over a long distance, which the industry does not have at present. This invention will receive the input of multiple flame sensors, process that information and produce a single or multiple output signals completely indistinguishable to the burner control. In addition it provides a communication means for transmitting the flame signal information into a format readily acceptable to computers and distributed control systems. The foregoing description of various preferred embodiments of the invention has been presented for the purposes of illustration and description. It is not intended to be exhaustive or to limit the invention to the precise forms disclosed. Obvious modifications or variations are possible in the light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A flame detection system for sensing flame in a single or multiple burner system reacting to the Ultra-Violet light emitted from a burner flame, comprising in combination,
a self-checking module functioning to determine the proper operation of the sensing element;
a micro-computer module which interprets the frequency pulses from the UV sensing tube and allows for degradation and changes in sensor sensitivity;
a flame signal generation module which creates and output flame signal proportional to the signal sensed at the sensing tube input and capable of interfacing to either a flame rod or an ultraviolet burner control system independent of their manufacturer.

2. The combination as set forth in claim 1 wherein the memory means includes non-volatile memory means for storing status information on the system, the non-volatile memory means having sufficient capacity to store information on all burners and maintain said storage in the event of power failure upon system shutdown.

3. The combination as set forth in claim 1 wherein the memory means includes a plurality of words of storage for storing information regarding system faults as they are detected for later scanning of the stored fault information to detect patterns therein.

4. The combination as set forth in claim 1 in which the control system includes a flame watchdog timer triggered by the processor and having an output serving as an enabling signal for fault relay which enables the flame sensing output.

5. The combination as set forth in claim 4 in which a flame present signal generated by the transmitting module when polling the flame sensor is operatively associated with the flame watchdog timer to enable the flame watchdog timer to respond to trigger pulses from the processor only in the presence of the flame present signal.

6. The combination as set forth in claim 5 wherein the flame watchdog timer has a reset input, and means coupling the reset input to the processor for enabling the flame watchdog timer in a normal mode to sense the flame present signal and provide an output signal to the transmitting module

7. The combination as set forth in claim 5 including a further watchdog timer having a trigger input connected to the microcomputer for being serviced periodically within the time constant of the further watchdog timer, an output from the further watchdog timer being connected to a fault relay for control thereof, the output of the watchdog timer serving to energize the fault relay and terminate the flame present signal in the event the further watchdog timer is not triggered by the processor.
